(19) United States
(12) Patent Application Publication
(10) Pub. No.: US 2024/0092648 A1
(43) Pub. Date: Mar. 21, 2024

(54) METHOD FOR RECOVERING MAGNESIUM IN SEAWATER AS HIGH-PURITY MAGNESIUM SULFATE

(71) Applicant: KOREA MARITIME UNIVERSITY INDUSTRY-ACADEMIC COOPERATION FOUNDATION, Busan (KR)

(72) Inventor: Myoung Jin KIM, Busan (KR)

(73) Assignee: KOREA MARITIME UNIVERSITY INDUSTRY-ACADEMIC COOPERATION FOUNDATION, Busan (KR)

(21) Appl. No.: 18/269,471

(22) PCT Filed: Dec. 28, 2021
(86) PCT No.: PCT/KR2021/020028

§ 371 Date: Jun. 23, 2023

(30) Foreign Application Priority Data
Dec. 28, 2020 (KR) 10-2020-0184462

(51) Int. Cl. C01F 5/40

(52) U.S. Cl. CPC C01F 5/40; C01P 2002/72; C01P 2002/88; C01P 2006/80

(57) ABSTRACT

A method for recovering high-purity magnesium sulfate includes: a pre-precipitation step of mixing an alkali precipitant and seawater; a concentration step of reacting a precipitate formed in the pre-precipitation step with sulfuric acid, followed by filtering to obtain a first eluate; a first precipitation step of adding ethanol to the first eluate, and then removing a first precipitated solid to obtain a second eluate; and a second precipitation step of precipitating magnesium sulfate solid by further adding ethanol to the second eluate from which the first precipitated solid has been removed.

### CROSS-REFERENCE TO PRIOR APPLICATIONS

This application is a National Stage Patent Application of PCT International Application No. PCT/KR2021/020028 (filed on Dec. 28, 2021), which claims priority to Korean Patent Application No. 10-2020-0184462 (filed on Dec. 28, 2020), which are all hereby incorporated by reference in their entirety.

### BACKGROUND

The present invention relates to a method for recovering magnesium in seawater as high-purity magnesium sulfate, and more particularly, to a method for recovering high-purity magnesium sulfate that includes adding ethanol to seawater twice to separate calcium and magnesium.

Recently, there has been a global trend of increasing seawater desalination plants to supply freshwater from the sea. However, the proper treatment and management of the brine generated from these plants can pose environmental issues because of the brine containing high-concentration salts, organic matters, and contaminants. If the brine generated from these plants is discharged into the ocean, it can cause a difference in salinity and as a result, disrupt the marine ecosystem due to major ion imbalances between the brine and seawater.

Meanwhile, the current mining industry faces challenges such as the depletion of high-grade minerals, increasing energy demands, and environmental issues, making it difficult to ensure a steady supply of minerals as in the past. Consequently, many countries have shown interest in recovering mineral resources from seawater to solve these problems. The primary mineral elements found in seawater include Na, Mg, Li, U, Ca, K, Sr, Br, B, Rb, and Cs. Among them, magnesium is the element with significant commercial value that is highly dissolved in seawater, second only to sodium. However, another element present in seawater, calcium, significantly impairs the purity of the magnesium compounds derived from seawater, hindering the efficient recovery of magnesium. Therefore, extensive research has been conducted to recover magnesium without calcium impurities from seawater.

Myung-Jun Kim (2016) added a carbonate solution to the brine with a magnesium-to-calcium weight ratio of 40:1 in order to selectively remove calcium. However, this reaction resulted in a loss of magnesium by approximately 10% relative to the feedstock. Khuyen Thi Tran (2013) added oxalate to the brine to remove calcium, impurities, thereby precipitating no more than 80% of calcium as calcium oxalate.

As mentioned above, the removal of calcium completely from the magnesium source is not easy and results in removing a large amount of magnesium as well, posing inefficiency by significantly reducing the magnesium recovery rate. Moreover, the conventional techniques for magnesium recovery without calcium impurities have required the use of additional chemical agents.

Accordingly, there is a need for the development of novel cost-effective technologies that require minimal use of non-reusable chemical agents and remove calcium but not magnesium.

### SUMMARY

It is an object of the present invention to provide a method for removing calcium impurities and recovering magnesium sulfate with a high purity of at least 99.8% by adding ethanol twice.

In an aspect of the present invention, there is provided a method for recovering high-purity magnesium sulfate that includes: a pre-precipitation step of mixing an alkali precipitant and seawater; a concentration step of reacting a precipitate formed in the pre-precipitation step with sulfuric acid, followed by filtering to obtain a first eluate; a first precipitation step of adding ethanol to the first eluate and then removing a first precipitated solid to obtain a second eluate; and a second precipitation step of further adding ethanol to the second eluate with the first precipitated solid removed therefrom, to precipitate magnesium sulfate solid.

The present invention discloses a method for recovering magnesium sulfate with a high purity of at least 99.8% as a final product.

Magnesium, the final product of the present invention, is an element with high utility value in high-value-added industries. It is mainly obtained from dolomite, seawater, seawater desalination concentrate, or brine. However, the aforementioned sources of magnesium generally contain significant amounts of calcium impurities. Calcium is a divalent cation like magnesium, so the separation of magnesium from calcium is not easy, requiring an additional process to separate magnesium from calcium.

The entire process of the present invention may include a pre-precipitation step using an alkali, a concentration step using sulfuric acid, and first and second precipitation steps using ethanol.

Through the pre-precipitation step, the magnesium contained in seawater can be precipitated in the form of a magnesium hydroxide precipitate. The precipitation of magnesium hydroxide is achieved through the following chemical equation (1):

MgCl₂(aq)+2OH⁻→Mg(OH)₂(s)+2Cl⁻ (1)

As mentioned above, by mixing an alkali precipitant with seawater, most of the magnesium in seawater can be precipitated into magnesium hydroxide solid. In this regard, the precipitate thus obtained may contain other impurities besides magnesium hydroxide.

As an exemplary embodiment, the present invention is characterized in that the alkali precipitant is any one selected from alkaline industrial byproducts consisting of sodium hydroxide, calcium hydroxide, paper sludge ash (PSA), cement kiln dust (CKD), fuel ash, bottom ash, fly ash, de-inking ash, slag, waste concrete, and mixtures thereof.

The alkali precipitant may be sodium hydroxide, calcium hydroxide, or paper sludge ash (PSA). The alkali precipitants such as calcium hydroxide and PSA may contain calcium. The calcium in the alkali precipitants can be removed through a subsequent process. The PSA, paper sludge ash, is one of the alkaline industrial byproducts.

As an exemplary embodiment, the present invention is characterized in that the seawater is any one selected from the group consisting of ordinary seawater, seawater desalination concentrate, brine, bittern, and mixtures thereof.

The seawater desalination concentrate refers to concentrated water obtained by desalination of seawater, that is, removing dissolved substances, including salts, from seawater. Desalination of seawater can be performed through an evaporation method, including multi-stage flash (MSF) and multi-effect distillation (MED), and a reverse osmosis method using osmosis in the opposite direction by allowing seawater to pass through a semi-permeable membrane to produce desalinated water.

The present invention may further include a process of washing the precipitate formed in the pre-precipitation step with water to remove impurities.

In the concentration step, the precipitate formed in the pre-precipitation step is reacted with sulfuric acid, followed by filtering to obtain a first eluate. The reaction between magnesium hydroxide in the precipitate and sulfuric acid can be represented by the following chemical equation (2):

Mg(OH)₂(s)+H₂SO₄→MgSO₄(aq)+₂H₂O (2)

Meanwhile, calcium carbonate solid as impurities may be incorporated into the precipitate formed in the pre-precipitation step. The calcium carbonate can react with sulfuric acid and precipitate into calcium sulfate as given by the following chemical equation (3):

CaCO₃(s)+H₂SO₄→CaSO₄(s)+H₂CO₃ (3)

However, due to the solubility (0.21 g CaSO₄/100 mL H₂O; 0.24 g CaSO₄·2H₂O/100 mL H₂O), the calcium sulfate may exist in the form of calcium ions as dissolved in the first eluate. Accordingly, the first eluate may contain high concentrations of calcium impurities, which can be separated from magnesium through the subsequent precipitation step.

The precipitation step for separating magnesium from calcium impurities can be divided into first and second precipitation steps.

This utilizes the difference in solubility between calcium sulfate and magnesium sulfate in ethanol. As the calcium sulfate has low solubility in ethanol, it can be quickly precipitated into a solid by adding a small amount of ethanol. In contrast, the magnesium sulfate has high solubility in ethanol, so a large amount of ethanol is required to precipitate the magnesium sulfate into a solid.

The first precipitation step is adding a small amount of ethanol to the first eluate to obtain a first precipitated solid and a second eluate. Here, the amount of ethanol may be small enough to precipitate calcium, but not magnesium.

As an exemplary embodiment, the present invention is characterized in that in the first precipitation step, the volume ratio of ethanol to the first eluate is 0.2˜0.4:1, when the magnesium concentration in the first eluate is 3 to 5 times the magnesium concentration in seawater and the calcium concentration in the first eluate is 0.5 to 1.5 times the calcium concentration in seawater.

The first precipitated solid may contain calcium as an impurity.

The calcium in the first precipitated solid can precipitate in the form of CaSO₄·2H₂O. The first precipitated solid may be removed after the first precipitation step.

The second precipitation step is adding a large amount of ethanol to the second eluate to precipitate magnesium sulfate.

As an exemplary embodiment, the present invention is characterized in that the total volume ratio of ethanol added in the first and second precipitation steps to the first eluate is 0.6˜2:1.

The second eluate, which is a filtrate with a large amount of calcium removed, may contain dissolved components not precipitated in the presence of a small amount of ethanol. If ethanol is further added to the second eluate in an amount enough to ensure thorough precipitation, the components not precipitated in the first precipitation step may start to precipitate. In this regard, the components further precipitated in the presence of a large amount of the additional ethanol may be mostly magnesium sulfate, likely in the form of MgSO₄·7H₂O or MgSO₄·H₂O.

As an exemplary embodiment, the present invention may further include a step of separating the precipitated magnesium sulfate solid after the second precipitation step, followed by drying at room temperature.

As an exemplary embodiment, the present invention may further include a step of recovering ethanol through fractional distillation of a filtrate remaining after precipitation of the magnesium sulfate solid in the second precipitation step.

Through the ethanol recovery step, ethanol can be recovered at a rate of up to 87% from the filtrate remaining after precipitation of the magnesium sulfate solid.

As an exemplary embodiment, the present invention is characterized in that the magnesium sulfate obtained by the recovery method has a purity of at least 99.8%.

According to the present invention, in comparison to conventional techniques, adding ethanol twice can minimize a loss of magnesium and remove most of calcium, thereby recovering magnesium sulfate with a high purity of 99.8%.

According to the present invention, the ethanol can also be recovered for reuse through fractional distillation, making it possible to recover magnesium sulfate in an economical and eco-friendly way.

### BRIEF DESCRIPTION OF THE DRAWINGS

FIG. 1 is a flow chart showing a method of recovering magnesium from seawater as high-purity magnesium sulfate.

FIG. 2 presents XRD graphs of the solids obtained in the pre-precipitation step.

FIG. 3 presents TGA graphs of the solids obtained in the pre-precipitation step.

FIG. 4 shows XRD graphs of the solids obtained in the concentration step.

FIG. 5 presents precipitation graphs of magnesium and calcium based on the volume ratio of ethanol to the first eluate in a one-step process.

FIG. 6 shows XRD graphs of the precipitated solids based on the volume ratio of ethanol to the first eluate in the one-step process.

FIG. 7 presents graphs showing the magnesium (Mg) and calcium (Ca) concentrations before and after adding ethanol with a volume ratio of ethanol to the first eluate being 0.4:1.

FIG. 8 presents a graph showing the solubility of calcium sulfate as a function of the amount of ethanol added.

FIG. 9 presents precipitation graphs of magnesium based on the total volume ratio of ethanol to the first eluate in a two-step process.

FIG. 10 shows XRD graphs of the solids precipitated through a one-step or two-step process with a volume ratio of ethanol to the first eluate being 1:1.

FIG. 11 presents graphs showing the purity of the solids precipitated through the one-step or two-step process with a volume ratio of ethanol to the first eluate being 1:1.

### DETAILED DESCRIPTION

Hereinafter, a detailed description will be given as to the exemplary embodiments of the present invention. The present invention can be subject to various modifications and take on different forms, and specific embodiments are provided in the drawings and described in detail in the specification. However, this is not intended to limit the present invention to specific embodiments, and it should be construed as including all the modifications, equivalents and alternatives within the spirit and scope of the present invention.

The terms “first,” “second,” and so on can be used to describe various components, but the components should not be limited by these terms. The terms are only used for the purpose of distinguishing one component from another.

Throughout the specification, when a particular part is said to “include” or “contain” certain components, unless specifically defined otherwise, it means that it can include additional components. Furthermore, singular expressions used in this specification encompass plural expressions unless explicitly indicated otherwise in the context.

Unless otherwise defined, all terms used here, including technical and scientific terminology, have the same meaning as those understood by a person skilled in the art in the relevant field of technology. Unless explicitly defined in this application, they are not to be interpreted in an idealized or overly formal sense.

Hereinafter, a further detailed description will be given as to the method for recovering magnesium from seawater as high-purity magnesium sulfate disclosed in the present invention with reference to the drawings of the present invention.

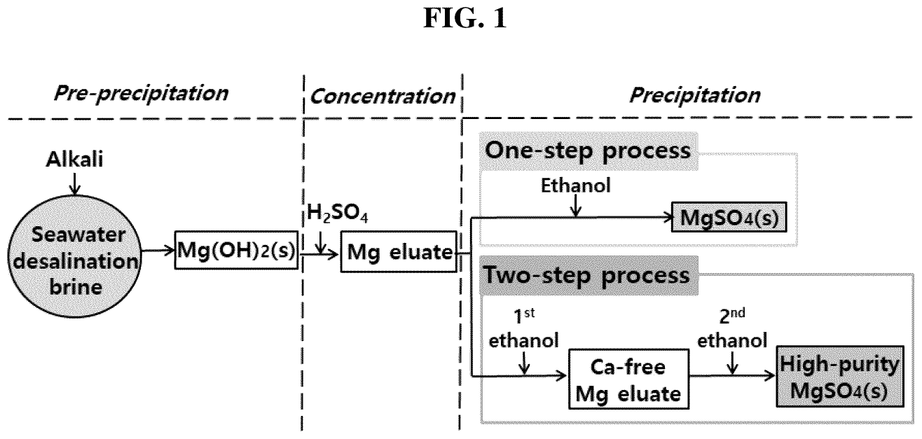

FIG. 1 is a flow chart showing the method for recovering magnesium from seawater as high-purity magnesium sulfate. The process of the present invention may be implemented through the following exemplary embodiments.

### EXAMPLES

### Example 1: One-Step Process Using Sodium Hydroxide as Alkali Precipitant

Seawater desalination concentrate was collected from a ‘K Desalination Plant’ in South Korea, filtered through a 0.45 μm membrane filter and stored in a refrigerator at 3° C.

Pre-precipitation step: 2 mL of a 10M sodium hydroxide solution was added as an alkali precipitant to 100 mL of the seawater desalination concentrate. The mixture of the seawater desalination concentrate and the alkali precipitant was stirred at 250 rpm for one hour. Subsequently, centrifugation was performed at 5,000 rpm for 30 minutes to obtain a pre-precipitated solid.

Concentration step: The pre-precipitated solid was mixed with 20 mL of 1M sulfuric acid (98%) and stirred at 250 rpm for one hour. Then, filtration was performed through a 0.45 μm membrane filter to obtain a first eluate in the form of a concentrate.

Precipitation Step: 20 mL of ethanol (99.9%) was added to 20 mL of the first eluate so that the ratio of ethanol to the first eluate was 1:1 (v:v). The mixture of the first eluate and ethanol was stood at room temperature (23.5° C.) for at least 6 hours. Then, filtration was performed through a 0.45 μm membrane filter to obtain a filtrate and a precipitated solid.

### Example 2: One-Step Process Using Calcium Hydroxide as Alkali Precipitant

The procedures were performed in the same manner as described in Example 1, excepting that 0.76 g of calcium hydroxide was used as an alkali precipitant.

### Example 3: One-Step Process Using PSA as Alkali Precipitant

The procedures were performed in the same manner as described in Example 1, excepting that 2.5 g of PSA was used as an alkali precipitant.

The PSA contained calcium carbonate, calcium hydroxide and calcium silicate, with a pH of 12.9 and an average particle size of 24.3 μm.

### Example 4: Two-Step Process Using Sodium Hydroxide as Alkali Precipitant

Seawater desalination concentrate was collected from a ‘K Desalination Plant’ in South Korea, filtered through a 0.45-μm membrane filter and stored in a refrigerator at 3° C.

Pre-precipitation step: 2 mL of a 10M sodium hydroxide solution was added as an alkali precipitant to 100 mL of the seawater desalination concentrate. The mixture of the seawater desalination concentrate and the alkali precipitant was stirred at 250 rpm for one hour. Subsequently, centrifugation was performed at 5,000 rpm for 30 minutes to obtain a pre-precipitated solid.

Concentration step: The pre-precipitated solid was mixed with 20 mL of 1M sulfuric acid (98%) and stirred at 250 rpm for one hour. Then, filtration was performed through a 0.45 μm membrane filter to obtain a first eluate in the form of a concentrate.

First precipitation Step: 8 mL of ethanol was added to 20 mL of the first eluate so that the ratio of ethanol to the first eluate was 0.4:1 (v:v). The mixture of the first eluate and ethanol was stood at room temperature (23.5° C.) for at least 6 hours. Then, filtration was performed through a 0.45 μm membrane filter to obtain a second eluate and a first precipitated solid.

Second precipitation Step: 12 mL of ethanol was further added to the second eluate so that the ratio of ethanol to the second eluate was 0.6:1 (v:v). In this regard, the total volume ratio of ethanol added in the first and second precipitation steps was 0.6˜2:1. The mixture of the second eluate and ethanol was stood at room temperature (23.5° C.) for at least 6 hours. Then, filtration was performed through a 0.45 μm membrane filter to obtain a filtrate and a second precipitated solid.

### Example 5: Two-Step Process Using Calcium Hydroxide as Alkali Precipitant

The procedures were performed in the same manner as described in Example 4, excepting that 0.76 g of calcium hydroxide was used as the alkali precipitant.

### Example 6: Two-Step Process Using PSA as Alkali Precipitant

The procedures were performed in the same manner as described in Example 4, excepting that 2.5 g of PSA was used as the alkali precipitant.

### Example 7: Two-Step Process Using Sodium Hydroxide as Alkali Precipitant

The procedures were performed in the same manner as described in Example 4, excepting that 4 mL of ethanol was further added in the second precipitation step so that the ratio of ethanol to the second eluate was 0.2:1.

### Example 8: Two-Step Process Using Sodium Hydroxide as Alkali Precipitant

The procedures were performed in the same manner as described in Example 4, excepting that 8 mL of ethanol was further added in the second precipitation step so that the ratio of ethanol to the second eluate was 0.4:1.

### Example 9: Two-Step Process Using Sodium Hydroxide as Alkali Precipitant

The procedures were performed in the same manner as described in Example 4, excepting that 22 mL of ethanol was further added in the second precipitation step so that the ratio of ethanol to the second eluate was 1.1:1.

### Example 10: Two-Step Process Using Sodium Hydroxide as Alkali Precipitant

The procedures were performed in the same manner as described in Example 4, excepting that 32 mL of ethanol was further added in the second precipitation step so that the ratio of ethanol to the second eluate was 1.6:1

### Evaluation Example

The solids of the Examples were analyzed in regards to the composition, characteristics and content using X-ray diffraction (XRD; SmartLab, Rigaku, Japan), X-ray fluorescence (XRF; XRF-1700, Shimadzu, Japan) and thermogravimetric analysis (TGA; TGA 7, Perkin Elmer, USA), respectively. As for the liquids of the Examples, the concentrations of calcium and magnesium and pH were determined using an atomic absorption spectrometer (AAS; AA 200, Perkin Elmer, USA) and a pH meter (Orion Star A211, Thermo Fisher Scientific, USA), respectively.

Test 1: pH and Composition Analysis of Seawater Desalination Concentrate

The seawater desalination concentrate used in the Examples of the present invention had a pH of 7.8 and the magnesium (Mg) and calcium (Ca) concentrations of 2.340 mg/L and 664 mg/L, respectively, with a weight ratio of Mg to Ca being 3.5:1.

Test 2: XRD of Solids in Pre-Precipitation Step

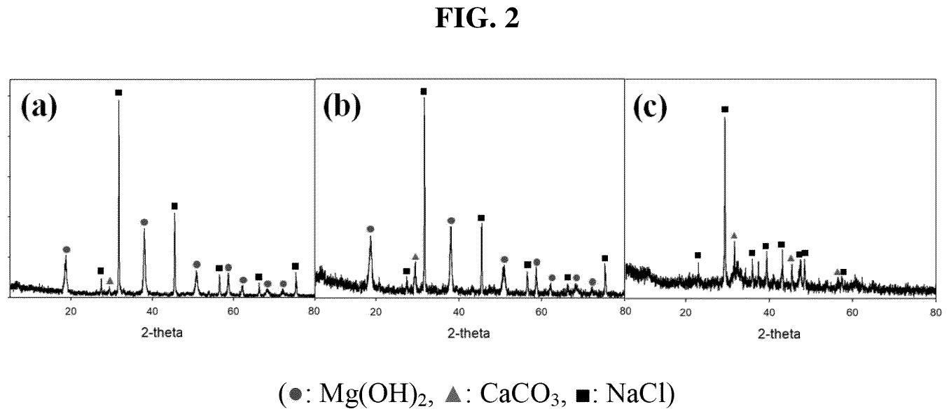

FIG. 2 presents XRD graphs of the solids obtained in the pre-precipitation step.

In FIG. 2, graphs of (a), (b) and (c) correspond to the Examples 4, 5 and 6, respectively. The graphs of (a) Example 4 and (b) Example 5 showed peaks of magnesium hydroxide, while no peak of magnesium hydroxide appeared in the graph of (c) Example 6. In addition, peaks of calcium carbonate and sodium chloride were observed in all the three graphs.

The magnesium precipitation efficiency acquired using sodium hydroxide, calcium hydroxide and PSA as a precipitant was 97.8%, 99.3% and 98.1%, respectively.

Test 3: TGA Analysis of Solids in Pre-Precipitation Step

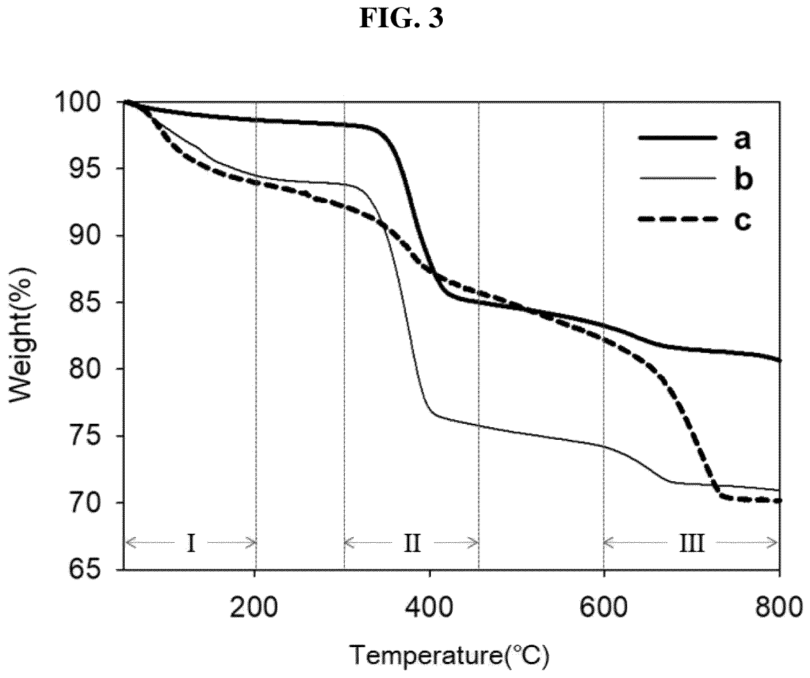

FIG. 3 presents TGA graphs of the solids obtained in the pre-precipitation step. In FIG. 3, graphs of (a), (b) and (c) correspond to the Examples 4, 5 and 6, respectively.

According to the graphs of FIG. 3, a weight loss occurred by H₂O in the temperature range of 50 to 200° C. (Zone I), by magnesium hydroxide in the temperature range of 300 to 450° C. (Zone II), and by calcium carbonate in the temperature range of 600 to 800° C. (Zone III). Contrary to the results of the XRD graphs, a weight loss of 4.8% by magnesium hydroxide was observed even in the Example 6. This indicates that as for the Example 6, no peak of magnesium hydroxide appeared in the XRD results, whereas the TGA analysis showed the formation of magnesium hydroxide, suggesting that magnesium hydroxide could be produced as a result of pre-precipitation even in the presence of PSA as an alkali precipitant.

Furthermore, a weight loss by calcium carbonate was observed in zone III. This indicates that even when using a precipitant not containing calcium, such as sodium hydroxide in the Example 4, calcium impurities could be formed through the pre-precipitation process by the calcium present in the seawater. Therefore, it demonstrates the need for an additional process to remove calcium.

Test 4: Analysis of Liquids in Pre-Precipitation Step

Regardless of the type of the precipitant, the supernatant obtained by removal of the pre-precipitated solid formed after the reaction between each of the three precipitants and the seawater desalination concentrate contained magnesium at a low concentration of 18-54 mg/L and calcium at a high concentration of 600-4,665 mg/L.

Test 5: XRD of Solids in Concentration Step

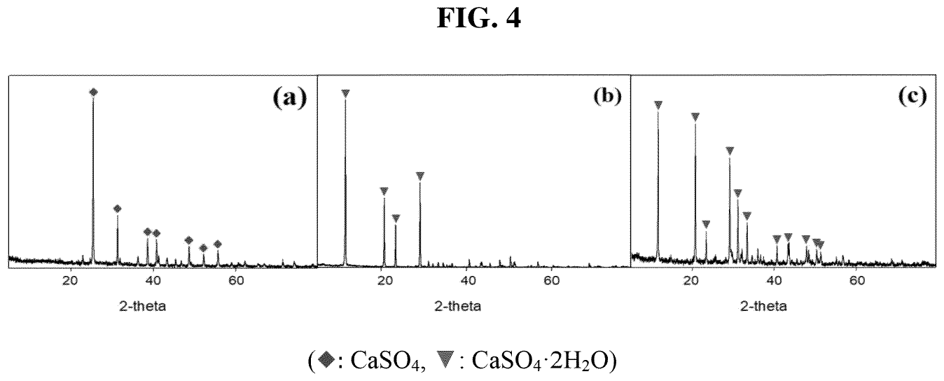

FIG. 4 presents XRD graphs of the solids obtained in the concentration stage. In FIG. 4, graphs of (a), (b) and (c) correspond to the Examples 4, 5 and 6, respectively.

As shown in the XRD spectra of FIG. 4, peaks corresponding to CaSO₄ or CaSO₄·2H₂O appeared regardless of the type of the precipitant.

The elution efficiency was 71.5%, 74.0%, and 71.2% when using sodium hydroxide, calcium hydroxide, and PSA as a precipitant, respectively.

Test 6: Analysis of Liquids in Concentration Step

The concentration of magnesium in the first eluate was in the range of 8,170 to 8,600 mg/L, showing a slight variation depending on the type of the precipitant. This magnesium concentration in the first eluate was 3.5 to 3.7 times higher than the magnesium concentration in the seawater desalination concentrate (2,340 mg/L).

Test 7: Analysis of Components in One-Step Process

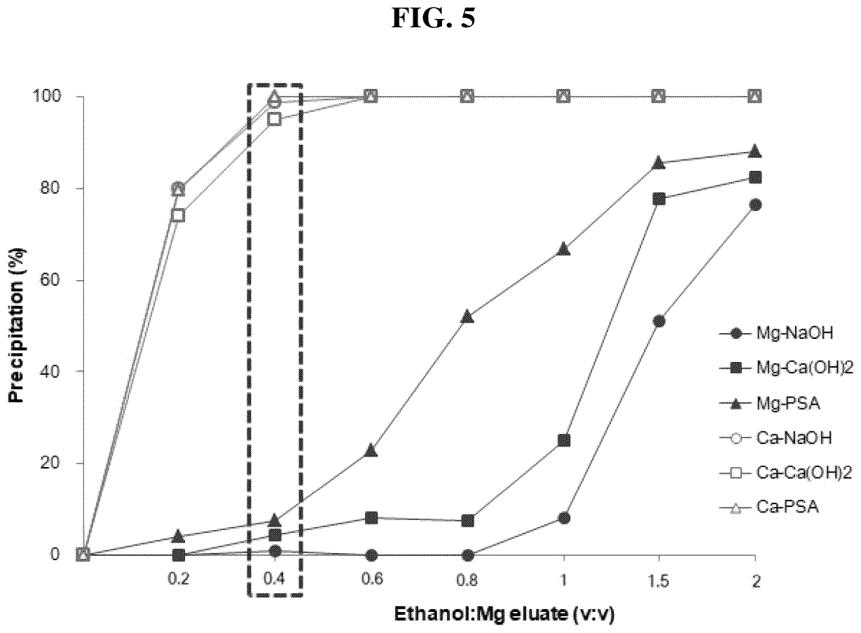

FIG. 5 presents the precipitation graphs of magnesium and calcium according to the volume ratio of ethanol to the first eluate in the one-step process. It shows the variation in precipitation efficiency of magnesium and calcium as a function of the volume ratio of ethanol to the first eluate.

Referring to FIG. 5, the precipitation efficiency of magnesium increased with an increase in the amount of ethanol used. In FIG. 5, the graph plotting the change in the magnesium precipitation efficiency as a function of the volume of ethanol forms an S-shaped curve, suggesting that the addition of ethanol abruptly reduced the solubility of magnesium sulfate, causing precipitation.

Furthermore, the precipitation efficiency of magnesium varied depending on the type of the precipitant, high in the order of Example 3, Example 2 and Example 1. The first eluate obtained in the Example 3 using PSA had pH 8.11. The first eluate of the Example 2 using calcium hydroxide and that of the Example 1 using sodium hydroxide had pH 0.71 and pH 0.77, respectively. It can be seen from these results that the precipitation reaction of magnesium sulfate could be further enhanced when the first eluate had a high pH value. The maximum precipitation efficiency was 76.4%, 82.6%, and 88.3% when using NaOH, Ca(OH)₂, and PSA as the precipitant, respectively.

As can be seen from FIG. 5, most of the calcium precipitated when the volume ratio of ethanol to the first eluate was at least 0.4:1. Contrarily, most of the magnesium did not precipitate when the volume ratio of ethanol to the first eluate was 0.2˜0.4:1. This suggests that the calcium precipitation efficiency was far higher than the magnesium precipitation efficiency because the solubility of calcium sulfate (substantially insoluble) was lower than that of magnesium sulfate (1.16 g/100 mL).

Test 8: XRD of Solids in One-Step Process

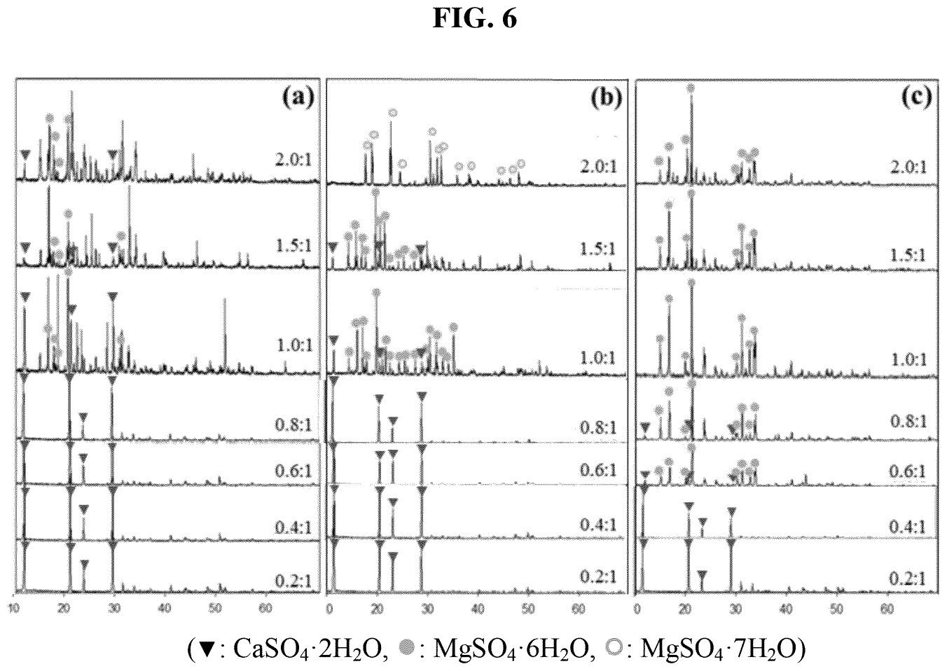

FIG. 6 shows XRD graphs of precipitated solids according to the volume ratio of ethanol to the first eluate in the one-step process. In FIG. 6, graphs of (a), (b) and (c) correspond to the Examples 1, 2 and 3, respectively.

Referring to FIG. 6, in all the cases of the three precipitants, when the volume ratio of ethanol to the first eluate was 0.2:1 to 0.4:1, only the peak of CaSO₄·2H₂O was observed, but no peaks appeared for MgSO₄·6H₂O or MgSO₄·7H₂O.

Subsequently, the peak for magnesium compound was observed when the volume of ethanol was increased to at least 0.4 times that of the first eluate.

Test 9: Analysis of Liquids Before/After Addition of Ethanol in First Precipitation Step of Two-Step Process

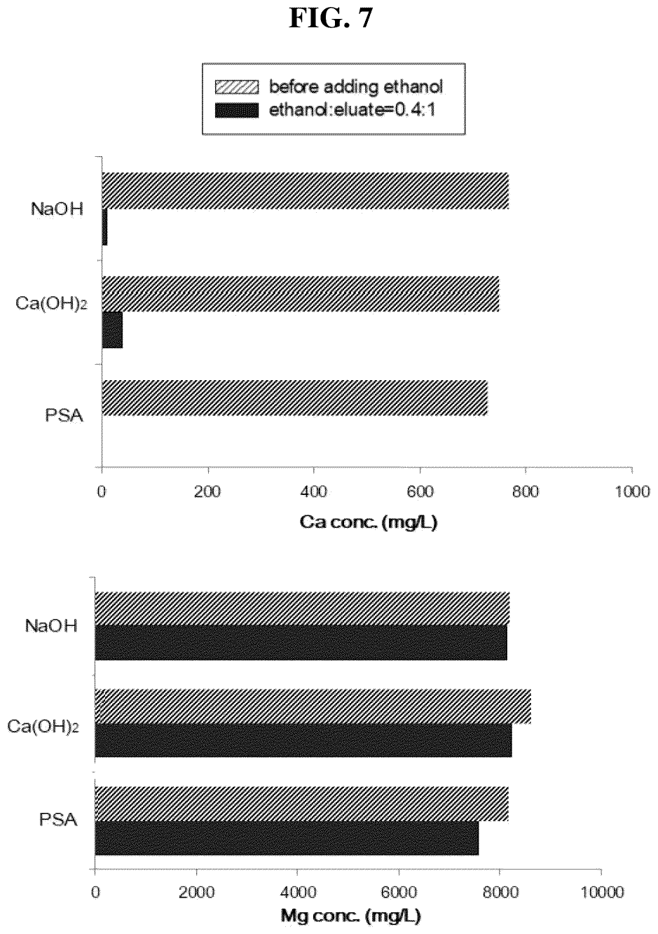

FIG. 7 presents graphs showing the concentrations of magnesium (Mg) and calcium (Ca) before and after adding ethanol at a volume ratio of ethanol to the first eluate being 0.4:1.

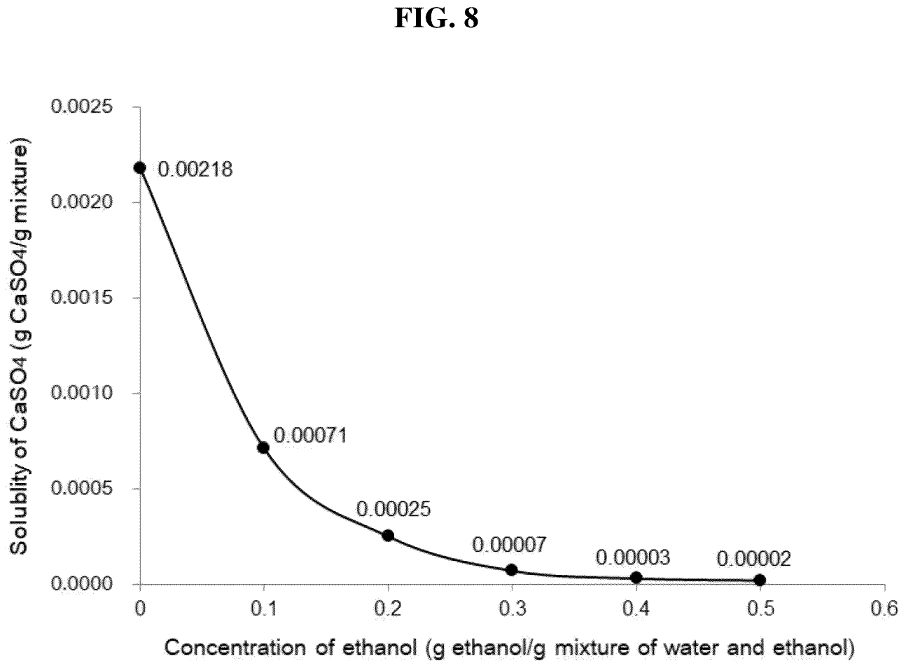

Referring to FIG. 7, in all the cases of the three precipitants, even with the addition of ethanol at a volume ratio of ethanol to the first eluate being 0.4:1, the precipitation yield of Mg was no more than 1.0 to 7.4%, and most of the Mg was not removed but remained in the solution. However, for all the three precipitants, the addition of ethanol at a volume ratio of ethanol to the first eluate of 0.4:1 resulted in the calcium precipitation efficiency ranging from 95% to 100% and the calcium concentration being decreased to about 0 to 37.5 mg/L. This result can be demonstrated in FIG. 8 below.

FIG. 8 presents a graph showing the solubility of calcium sulfate (CaSO₄) as a function of the amount of ethanol. This graph is plotting the solubility of CaSO₄ in the water-ethanol mixtures as derived by Gomis et al. (CaSO₄ solubility in water-ethanol mixtures in the presence of sodium chloride at 25° C. Application to a reverse osmosis process, Fluid Ph. Equilibria, 360 (2013) 248-252, https://doi.org/10.1016/j.fluid.2013.09.063). Referring to the graph, the solubility of calcium sulfate decreased with an increase in the volume ratio of ethanol. With the volume ratio of ethanol being 0.4:1, the solubility of calcium sulfate was about 0.00003 g/mixture g, close to zero. Therefore, it is predicted that calcium sulfate could precipitate as a solid rather than dissolve.

Test 10: Mg Precipitation in Second Precipitation Step of Two-Step Process

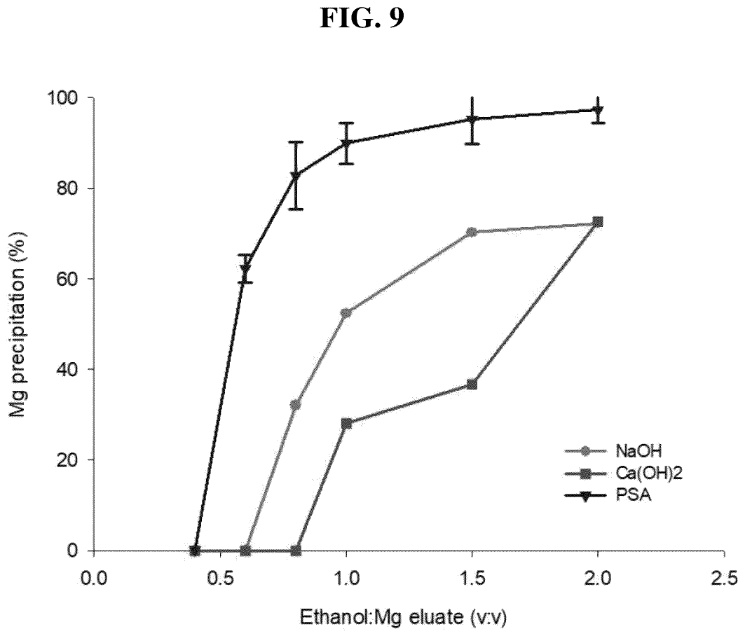

FIG. 9 presents precipitation graphs of magnesium (Mg) as a function of the total volume ratio of ethanol to the first eluate in the two-step process. The graphs represent the Mg precipitation efficiency in the second precipitation step in Examples 4, 5 and 6.

The Mg precipitation efficiency increased with an increase in the total volume ratio of ethanol to the first eluate from 0.4˜0.6:1 to 2:1.

The maximum precipitation efficiency of Mg was 72.3%, 72.5%, and 95.9% in the case of using NaOH, Ca(OH)₂, and PSA as a precipitant, respectively.

In the same manner as observed in the one-step process, the magnesium precipitation efficiency was highest in the Example 6 using the first eluate with the highest pH value, i.e., PSA.

Test 11: XRD of Final Solid Products

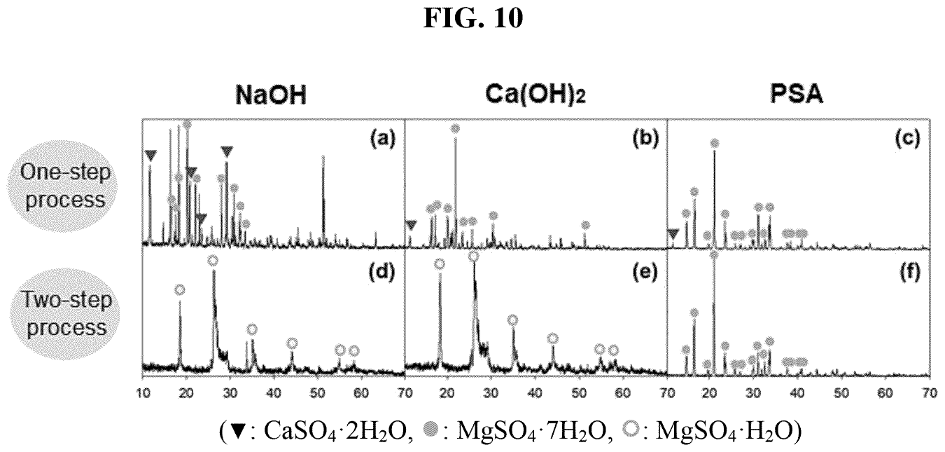

FIG. 10 presents XRD graphs of the precipitated solids manufactured in the one-step or two-step process with a volume ratio of ethanol to the first eluate being 1:1.

In FIG. 10, graphs of (a) to (f) correspond to the Examples 1 to 6, respectively.

Referring to the graphs, in Examples 1, 2 and 3, which involved the one-step process, the final products contained impurities of CaSO₄·2H₂O. In contrast, in Examples 4, 5 and 6, which involved the two-step process, no peaks other than those of MgSO₄·7H₂O or MgSO₄·H₂O appeared. As can be seen from the results, the magnesium sulfate manufactured through the two-step process of the present invention had a high purity, because the two-step process of the present invention was excellent in removing calcium impurities, whereas the one-step process had an inefficient effect to remove calcium impurities.

Test 12: Qualitative Analysis of Final Solid Products

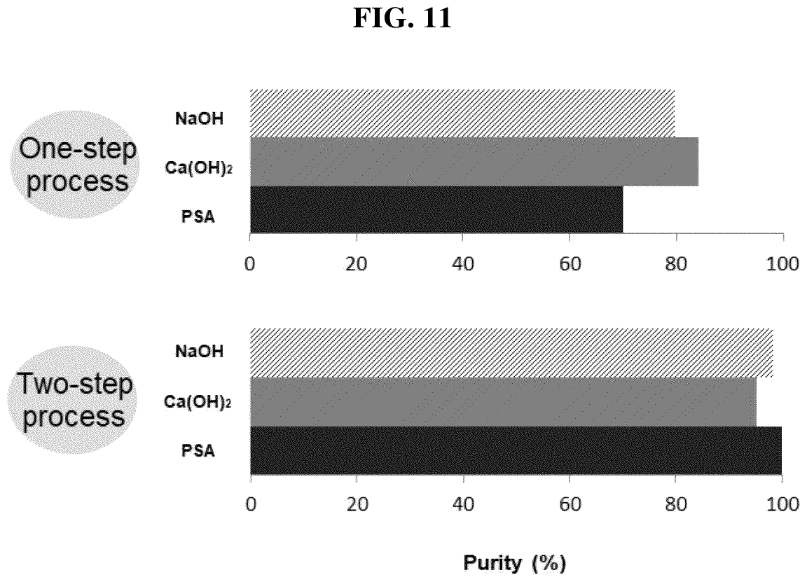

FIG. 11 presents graphs showing the purity of the precipitated solids manufactured through the one-step or two-step process with a volume ratio of ethanol to the first eluate being 1:1.

Referring to FIG. 11, the magnesium sulfate produced by the two-step process had a high purity of 95.1% to 99.8%, regardless of the type of the precipitant used in the process and contained a small amount of impurities other than calcium, such as sodium, potassium, and silicon.

Contrarily, the magnesium sulfate produced from the one-step process using sodium hydroxide, calcium hydroxide or PSA as a precipitant had a low purity of 69.9%, 84.1% or 89.6%, respectively, all lower than the purity of the magnesium sulfate obtained from the two-step process. The calcium impurity content in the two-step process was 0% to 4.3%, significantly lower than the calcium impurity content in the one-step process that was 6.7% to 29.3%. This indicates that the two-step process of the present invention was far superior in removing calcium impurities and producing high-purity magnesium sulfate to the conventional one-step process.

Although the present invention has been described with reference to the preferred embodiments of the present invention, it should be understood by those skilled in the art that various modifications and changes can be made to the present invention within the scope of the claims set forth below, without departing from the spirit and scope of the present invention as defined by the claims below.

1. A method for recovering high-purity magnesium sulfate, comprising:
a pre-precipitation step of mixing an alkali precipitant and seawater;
a concentration step of reacting a precipitate formed in the pre-precipitation step with sulfuric acid, followed by filtering to obtain a first eluate;
a first precipitation step of adding ethanol to the first eluate and then removing a first precipitated solid to obtain a second eluate; and
a second precipitation step of further adding ethanol to the second eluate from which the first precipitated solid has been removed, to precipitate magnesium sulfate solid.

2. The method according to claim 1, wherein the alkali precipitant is any one selected from alkaline industrial byproducts consisting of sodium hydroxide, calcium hydroxide, paper sludge ash (PSA), cement kiln dust (CKD), fuel ash, bottom ash, fly ash, de-inking ash, slag, waste concrete, and mixtures thereof.

3. The method according to claim 1, wherein the seawater is any one selected from the group consisting of ordinary seawater, seawater desalination concentrate, brine, bittern, and mixtures thereof.

4. The method according to claim 1, wherein in the first precipitation step, the volume ratio of ethanol to the first eluate is 0.2˜0.4:1, when the magnesium concentration in the first eluate is 3 to 5 times the magnesium concentration in seawater and the calcium concentration in the first eluate is 0.5 to 1.5 times the calcium concentration in seawater.

5. The method according to claim 1, wherein the total volume ratio of ethanol added in the first and second precipitation steps is 0.6˜2:1.

6. The method according to claim 1, further comprising a step of separating the precipitated magnesium sulfate solid after the second precipitation step, followed by drying at room temperature.

7. The method according to claim 1, further comprising a step of performing fractional distillation of a filtrate remaining after precipitation of the magnesium sulfate solid to recover ethanol, after the second precipitation step.

8. The method according to claim 1, wherein the magnesium sulfate obtained by the recovery method has a purity of at least 99.8%.
